(19) United States
(12) Patent Application Publication
(10) Pub. No.: US 2018/0113518 A1
(43) Pub. Date: Apr. 26, 2018

(54) MOUSE HAVING DIGITAL KEY AND ANALOG KEY

(71) Applicants: DEXIN ELECTRONIC LTD., DONGGAUN GUANGDONG (CN); DEXIN CORPORATION, NEW TAIPEI CITY (TW)

(72) Inventor: YI-SHUN CHEN, NEW TAIPEI CITY (TW)

(21) Appl. No.: 15/620,067

(22) Filed: Jun. 12, 2017

(30) Foreign Application Priority Data
Oct. 21, 2016 (TW) 105134107

(51) Int. Cl. G06F 3/038; G06F 3/0487

(52) U.S. Cl. CPC G06F 3/038; G06F 3/03543; G06F 3/0487

(57) ABSTRACT

A mouse having a digital key and an analog key includes a mouse body having at least one first key and at least one second key, at least one digital switch disposed at a position corresponding to the first key, and at least one analog switch disposed at a position corresponding to the second key. The analog switch has a magnetic element and a magnetic sensor, the magnetic element is connected to the second key, and the magnetic sensor is disposed at a position corresponding to the magnetic element. When the second key is pressed by a user, a relative distance of the magnetic element and the magnetic sensor change, so that a strength of an analog signal output from the analog switch is changed relative to the distance of the magnetic element and magnetic sensor.

### BACKGROUND

The disclosure relates to a mouse having a digital key and an analog key, more particularly, to a computer input device having both digital and analog signal keys.

A keyboard and mouse are the most common input devices for conventional computers. A conventional mouse has at least two left and right buttons, and a scroll wheel button located between the left and right keys. There are a variety of video games that are popular among gamers and that catch the public eye. It is not uncommon for skilled players to host public livestreams during their gameplay sessions, which also attracts popularity.

Players who possess superb gameplay mechanics or strategy often choose a career in video games, i.e. competitive gamers. Over the years, video games have evolved toward competitive play; the mouse is often clicked more than a hundred times throughout the span of just one game.

However, the typical conventional mouse only outputs a digital signal. The internal sensor switch of the conventional mouse can only detect whether or not the user has clicked the button, and cannot sense the pressure or depth of the clicking action. This prevents the video games from being controlled with more precision, which may cause inconveniences in gameplay.

The abovementioned drawbacks of the conventional mouse seem to suggest that there is still room for improvement in the art.

### SUMMARY

A main object of the present disclosure is to solve the drawbacks associated with the conventional mouse, that the key-press motion sensor has only a digital signal, and that the pressure and depth of the mouse button clicking action cannot be detected.

Accordingly, a mouse of the present disclosure includes a mouse body, at least one digital switch, and at least one analog switch.

The mouse body has at least one first key and at least one second key disposed thereon, and an accommodating space formed therein.

The at least one digital switch is disposed in the accommodating space of the mouse body at a position corresponding to the at least one first key. When the at least one first key is pressed, the at least one digital switch is touched by the at least one first key and outputs a digital signal.

The at least one analog switch has a magnetic element and a magnetic sensor. The magnetic sensor is capable of outputting an analog signal when the magnetic element approaches the magnetic sensor. A strength of the analog signal changes with a distance between the magnetic element and the magnetic sensor.

The magnetic element is disposed on the second key, and the magnetic sensor is disposed in the mouse body at a position corresponding to the magnetic element. When the second key is pressed, a relative distance between the magnetic element and the magnetic sensor is changed so that a strength of the analog signal output from the analog switch is changed according to the relative distance.

In order to further the understanding of the present disclosure, the following embodiments are provided along with appended drawings to facilitate the detailed explanation of the present disclosure.

### BRIEF DESCRIPTION OF THE DRAWINGS

FIG. 1 is a perspective view of a first embodiment of a mouse having a digital key and an analog key according to the present disclosure.

FIG. 2 is a cross-sectional view of the first embodiment of the mouse having a digital key and an analog key according to the present disclosure.

FIG. 3 is a cross-sectional view of the first embodiment of the mouse having a digital key and an analog key with a second key in a pressed status according to the present disclosure.

FIG. 4 is a perspective view of a second embodiment of the mouse having a digital key and an analog key according to the present disclosure.

FIG. 5 is a cross-sectional view of a third embodiment of the mouse having a digital key and an analog key according to the present disclosure.

FIG. 6 is a cross-sectional view of a fourth embodiment of the mouse having a digital key and an analog key according to the present disclosure.

FIG. 7 is a cross-sectional view of a fifth embodiment of the mouse having a digital key and an analog key according to the present disclosure.

### DETAILED DESCRIPTION

### First Embodiment

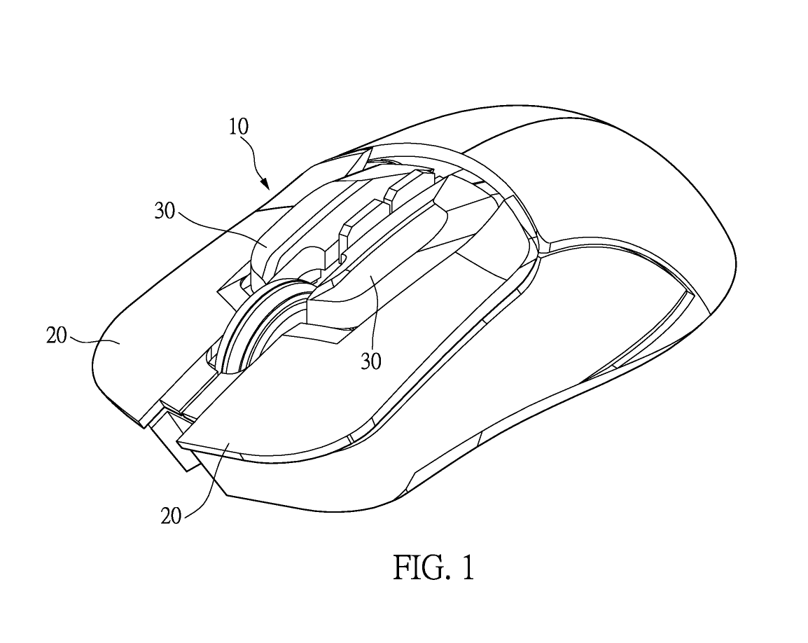

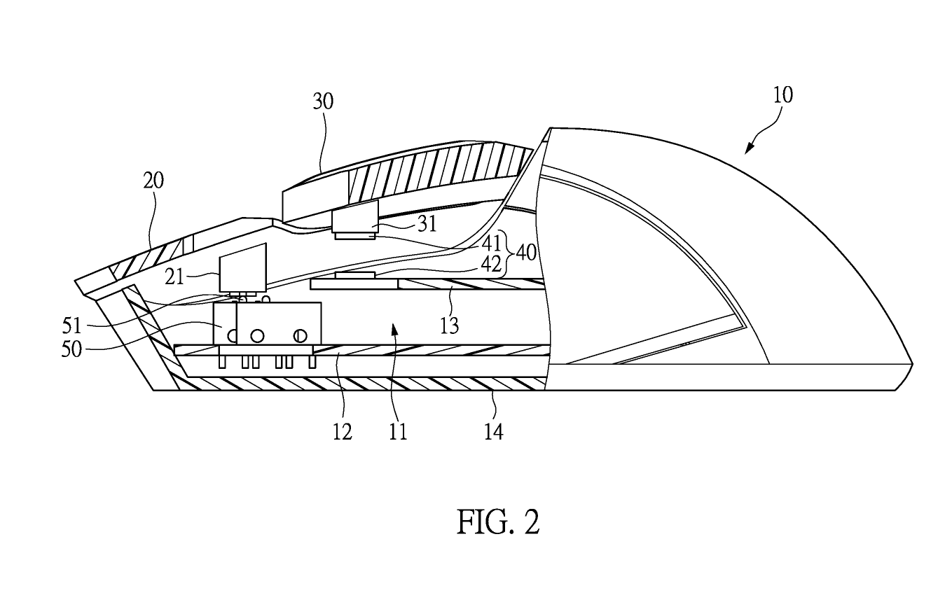

Referring to FIGS. 1 to 3, which show a first embodiment of the mouse having a digital key and an analog key of the present disclosure, the present disclosure includes a mouse body 10. In this embodiment, the mouse body 10 is a plastic injection molded case. A top surface of the mouse body 10 is formed with a curved surface suitable for being gripped by the palm of a user, a bottom surface of the mouse body 10 is formed with a base 14, and an inside of the mouse body 10 is formed with an accommodating space 11.

For convenience, in the following description, the side of the mouse body 10 having the base 14 will be hereunder referred to as the “bottom,” while the side of the mouse body 10 opposite to the base 14 will be hereunder referred to as the “top.” However, the directional terms adopted hereunder are merely for convenience in explaining the relative positions of the elements of the present disclosure, and do not limit the technical content of the present disclosure.

On the front portion of the top surface of the mouse body 10, two first keys 20 are provided, and two second keys 30 are provided on the top surface of the mouse body 10 adjacent to the rear side of the first keys 20. The bottom surface of the first keys 20 is provided with a projecting first protrusion 21, further, a second protrusion 31 is provided on the bottom surface of the second key 30, respectively. The first key 20 and the second key 30 are provided on the top surface of the mouse body 10 in such a manner that they can be displaced up and down. An operator can press a finger to displace downwardly the first and second keys 20, 30.

It should be noted that, the number of the first keys 20 and the second keys 30 is not limited to the number disclosed in the drawings, and the position of the arrangement is not limited to the position disclosed by the drawings, but can be designed and arranged on the mouse body 10 at various appropriate positions according to actual needs.

The accommodating space 11 inside the mouse body 10 is provided with a first circuit board 12, and a second circuit board 13. The first circuit board 12 is a main circuit board of a mouse. The mouse's various main control circuits and circuit elements such as a sensor are disposed on the first circuit board 12. In this embodiment, on the first circuit board 12, a digital switch 50 is provided at a position corresponding to the bottom surface of the two first keys 20. Each of the digital switch 50 has a triggering part 51, and when the first keys 20 is pressed by an operator's finger, the triggering part 51 of the digital switch 50 can be touched by the bottom end of the first protrusion 21 on the bottom surface of the first key 20, thereby causing the digital switch 50 to generate a digital signal.

In this embodiment, a second circuit board 13 is provided in the accommodating space 11 of the mouse body 10, and an analog switch 40 is provided at a position corresponding to the second key 30 on the second circuit board 13 to produce an analog signal. In this embodiment, the analog switch 40 includes a magnetic element 41 and a magnetic sensor 42, the magnetic element 41 may be a magnet, a lodestone, or other elements with magnetic properties. The magnetic element is disposed at the bottom of the second protrusion 31 of the second key 30. The magnetic sensor 42 is provided on the second circuit board 13 at a position corresponding to the magnetic element 41. In this embodiment, the magnetic induction magnetic sensor 42 is a Hall inductive element, the magnetic sensor 42 is capable of sensing the magnetic field of the magnetic element 41, and outputs a voltage, thereby generating an analog signal, and when the distance between the magnetic element 41 and the magnetic induction analog switch 40 is changed, the intensity of the analog signal produced by the magnetic sensor 42 also changes.

It should be noted that, in this embodiment, although the first circuit board 12 and the second circuit board 13 are provided inside the mouse body 10, in use, the first circuit board 12 and the second circuit board 13 may be formed as one, or the second circuit board 13 may be omitted so that the analog switch 40 is directly disposed on the first circuit board 12. Alternatively, the magnetic sensor 42 of the analog switch 40 may not be directly disposed on the circuit board, but may be provided in the inside of the mouse body 10 and spaced apart from the first circuit board 12 or the second circuit board 13; then be electrically connected to the circuit board via cables or flexible printed circuit boards.

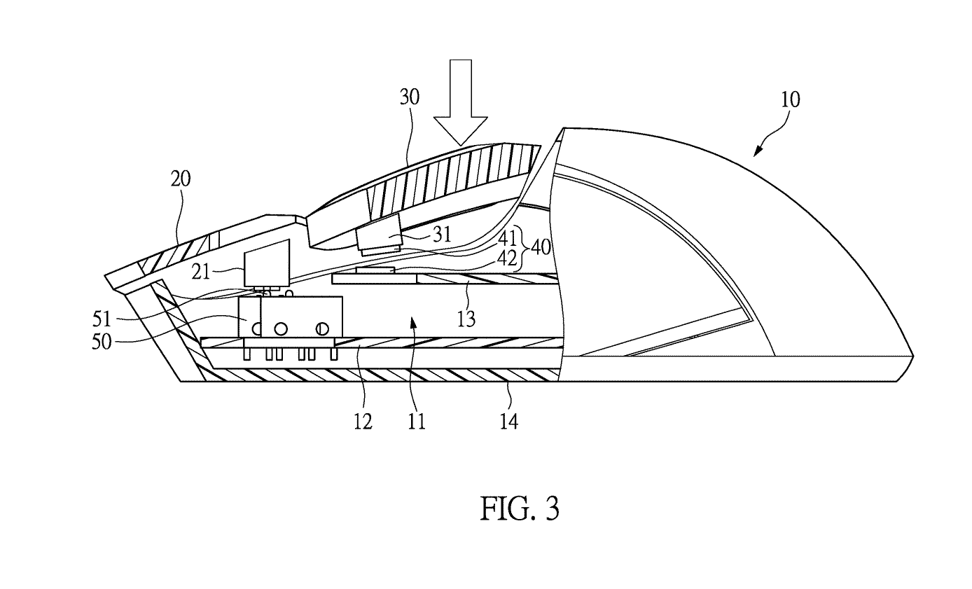

As shown in FIG. 3, because of the connection of the magnetic element 41 and second key 30, the vertical displacement of the second key 30 when pressed by the user would change the relative distance between the magnetic element 41 and the magnetic sensor 42, thus changing the intensity of analog signals outputted from magnetic sensor 42.

Through the aforementioned structure of the mouse according to the present disclosure, the user can press the digital switch 50 via the first key 20 to generate a digital signal. When gaming with the mouse, users can press the first key 20 for distinct actions such as firing a gun for shooting games, or slashing at an enemy or pointing and clicking for action games.

When users press the second key 30, the relative distance between the magnetic element 41 and the magnetic sensor 42 of the analog switch 40 would vary according to the depth of the pressing action, and thus enables the analog switch 40 to sense the pressing depth or pressure from the user's finger, thereby changing the intensity of the outputted analog signal continuously and steplessly. This allows the mouse to produce actions similar to that of the L2/R2 buttons on a gamepad.

When users use the mouse of the present disclosure for gaming, the second key 30 empowers users with more delicate controls by virtue of its pressure sensing feature. For example, the force of serving or hitting a ball in a sports game may be determined by the depth or pressure of the second key 30 when pressed; speeding up or braking a vehicle in a driving game may depend upon the depth of the second key 30; steering angles may be determined by the depth of the second key 30; control of the throttle or flaps in a flight simulator may rely on the delicate controls offered by the second key 30; and in MMORPGs, the swinging power of a weapon can be decided by the depth or pressure of the second key 30.

### Second Embodiment

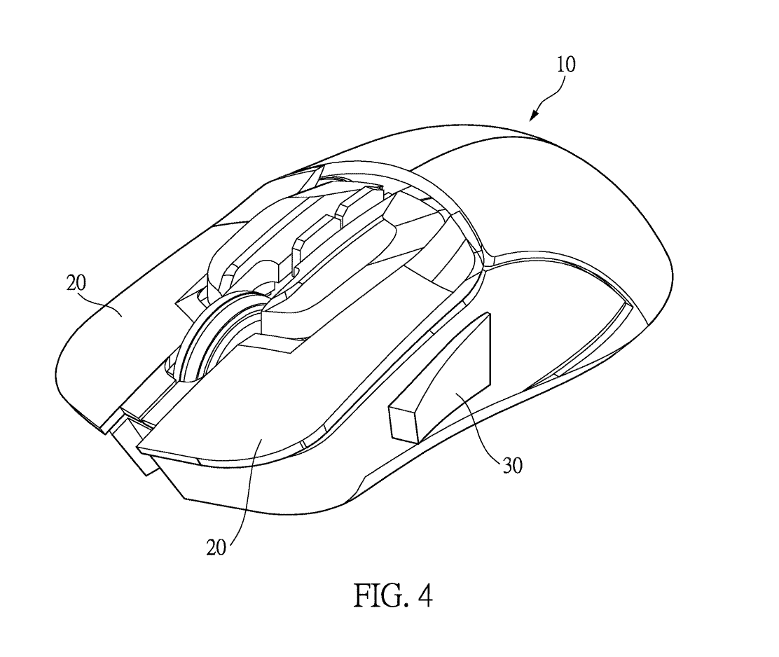

Referring to FIG. 4, a second embodiment of the present disclosure is shown. The second embodiment is similar to the first embodiment, except that the second key 30 of the second embodiment is disposed on a side surface of the mouse body 10 rather than on the top surface.

By positioning the second key 30 away from the first key 20, the user is able to press the second key 30 with a finger different from the one used to press the first key 20 (e.g., the thumb or ring finger), so as to improve the operational convenience and ergonomics of the mouse.

### Third Embodiment

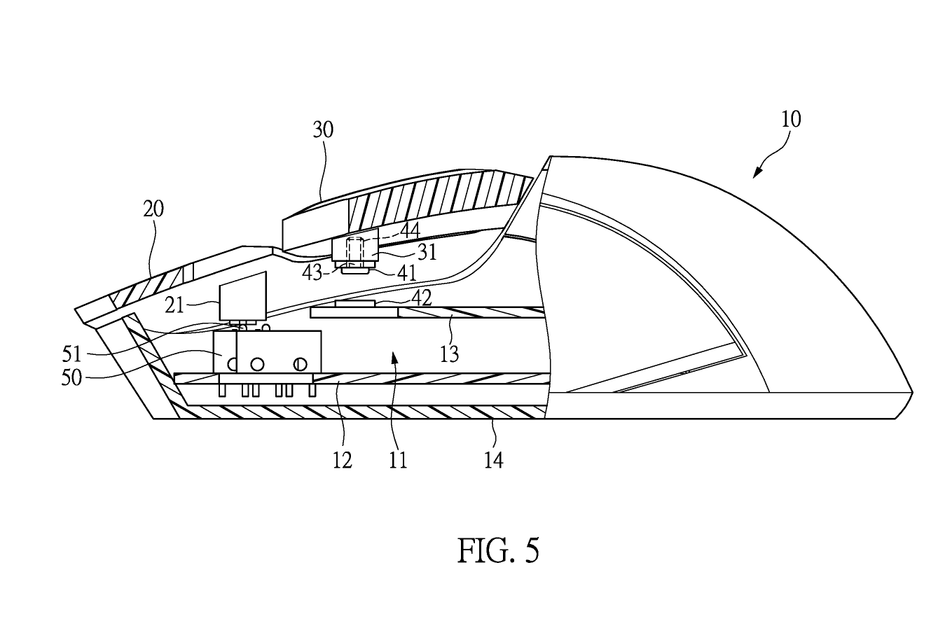

Referring to FIG. 5, a third embodiment of the present disclosure is shown. The feature of the third embodiment resides in that a position adjusting component is disposed between the bottom of the second protrusion of the second key 30 and the magnetic element 41. In this embodiment, the position adjusting component includes an adjusting screw 43 connected to the magnetic element 41, and a screw hole 44 formed in the bottom of the second protrusion 31. The adjusting screw 43 locks into the screw hole 44, so that the user rotate the adjusting screw 43 to change the relative distance between the magnetic element 41 and the bottom of the second protrusion 31 along the longitudinal direction, thus achieving the purpose of adjusting the relative positions of the magnetic element 41 and the bottom of the second protrusion 31.

In use, the user can change the position of the magnetic element 41 on the second protrusion 31, such that the relative positions of the magnetic element 41 and the magnetic sensor 42 are also changed. Thereby enabling the fine-tuning of operating parameters such as actuating strokes, sensitivity, and signal intensity of the analog switch 40.

### Fourth Embodiment

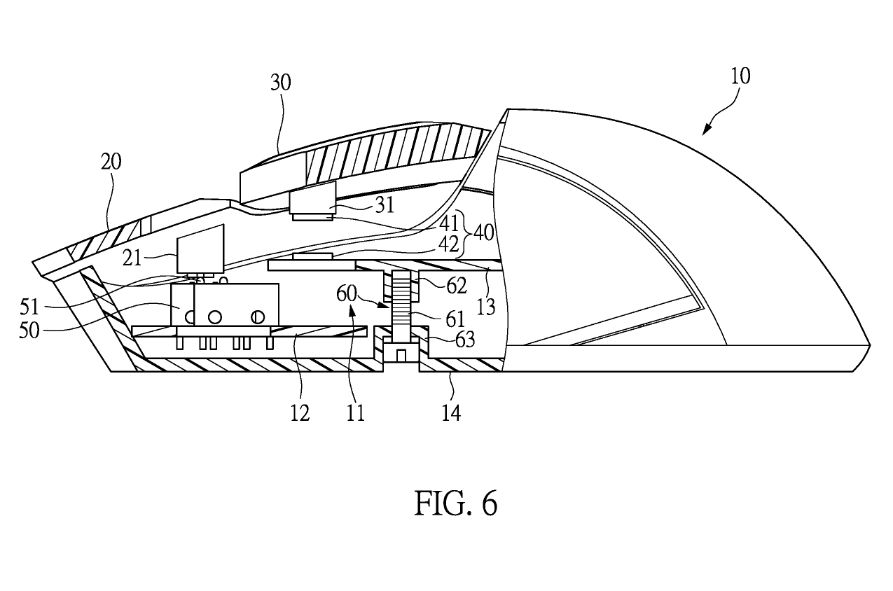

Referring to FIG. 6, a fourth embodiment of the present disclosure further has a height adjusting mechanism 60, which adjusts the relative height between the magnetic sensor 42 and the base 14 of the mouse body 10. In this embodiment, the height adjusting mechanism 60 includes a height adjusting screw seat 63 disposed on the base 14, a height adjusting screw 61, and a sleeve 62 disposed on the bottom surface of the circuit board 13.

The height adjusting screw 61 extends through the bottom surface of the base 14 and into the height adjusting screw seat 63 such that an end of the height adjusting screw 61 is locked in the sleeve 62. Since the height adjusting screw 61 and the sleeve 62 are threadedly engaged, rotation of the height adjusting screw 61 also drives the sleeve 62 to move vertically, thus changing the height of the second circuit board 13 so that the height of the magnetic sensor 42 of the second circuit board 13 is also changed.

By virtue of the height adjusting mechanism 60, the height of the magnetic sensor 42 relative to the base 14 can be changed, such that the relative positions of the magnetic element 41 and the magnetic sensor 42 are changed, thereby enabling the fine-tuning of operating parameters such as actuating strokes, sensitivity, and signal intensity of the analog switch 40.

### Fifth Embodiment

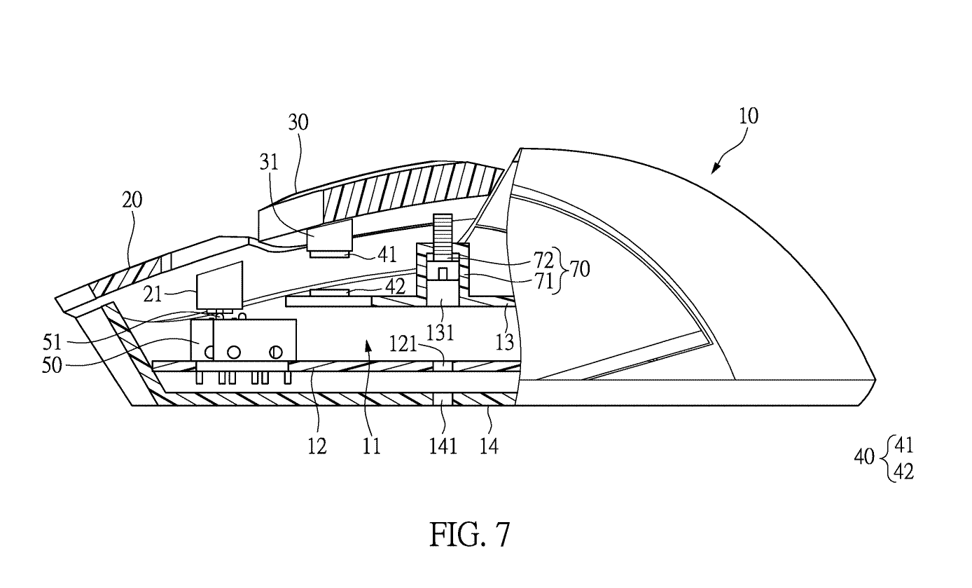

Referring to FIG. 7, a fifth embodiment of the present disclosure further has a limiting mechanism 70, which adjusts the pressing stroke of the second key 30. As shown in FIG. 7, in this embodiment, the limiting mechanism includes a limit adjusting screw 72, and a limit adjusting screw seat 71 disposed on the second circuit board 13. The limit adjusting screw 72 is locked into the limit adjusting screw seat 72 in a bottom-up direction, and may move in a vertical direction when rotated.

An end of the limit adjusting screw 72 is positioned near and may be contacted by the bottom surface of the second key 30, so that when the second key 30 is pressed, the position of the bottom dead center of the downward moving stroke is limited by the limit adjusting screw 72, thereby achieving the purpose of limiting and adjusting the pressing stroke of the second key 30.

In order to allow users to easily adjust the pressing stroke of the second key 30, in this embodiment, a base through hole 141 is further formed in the base 14 of the mouse body 10 at a position corresponding to that of the limit adjusting screw 72. In addition, a first through hole 121 and a second through hole 131 are respectively formed at positions corresponding to that of the first circuit board 12 and the second circuit board 13, so that the user can insert a screwdriver into the mouse body 10 to rotate and adjust the height of the limit adjusting screw 72.

By adjusting the height of the bottom dead center of the downward pressing stroke via the limit adjusting screw 72, the user can adjust the pressing stroke of the mouse according to game types or personal preferences so that more delicate controls can be achieved in gaming.

The descriptions illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A mouse having a digital key and an analog key, comprising:
a mouse body having at least one first key and at least one second key disposed thereon, the mouse body having an accommodating space formed therein;
at least one digital switch disposed in the accommodating space of the mouse body at a position corresponding to the at least one first key, such that when the at least one first key is pressed, the at least one digital switch is contacted by the at least one first key and outputs a digital signal; and
at least one analog switch having a magnetic element and a magnetic sensor, the magnetic sensor being capable of outputting an analog signal when the magnetic element approaches the magnetic sensor, and a strength of the analog signal changing with a distance between the magnetic element and the magnetic sensor;
wherein the magnetic element is disposed on the second key, the magnetic sensor is disposed in the mouse body on a position corresponding to the magnetic element, and when the second key is pressed, a relative distance between the magnetic element and the magnetic sensor is changed, so that a strength of the analog signal output by the analog switch is changed according to the relative distance.

2. The mouse having a digital key and an analog key according to claim 1, wherein the magnetic element is a magnet or a lodestone, and the magnetic sensor is a Hall effective element.

3. The mouse having digital key and an analog key according to claim 2, wherein a bottom of the second key is provided with a protrusion from the bottom of the second key, the magnetic element is disposed at an end of the protrusion, and the circuit board is disposed in the accommodating space of the mouse body.

4. The mouse having a digital key and an analog key according to claim 3, further comprising a position adjusting component disposed between the bottom end of the protrusion and the magnetic element for adjusting the relative distance between the magnetic element and the end of the protrusion.

5. The mouse having a digital key and an analog key according to claim 4, wherein the position adjusting component includes an adjustment screw attached to the magnetic element, and a screw hole formed at the bottom end of the protrusion, the adjusting screw being locked in the screw hole.

6. The mouse having a digital key and an analog key according to claim 3, wherein the mouse body has a base, and a height adjusting mechanism is disposed between the magnetic sensor and the base for changing a relative distance between the magnetic sensor and the magnetic element.

7. The mouse having a digital key and an analog key according to claim 6, wherein the height adjusting mechanism includes a height adjusting screw seat disposed the base, a height adjusting screw, and a sleeve disposed on a bottom surface of the circuit board, the height adjusting screw passing through the height adjusting screw seat and being locked into the sleeve to adjust the height of the sleeve and the circuit board.

8. The mouse having a digital key and an analog key according to claim 3, further comprising a limiting mechanism for adjusting a pressing stroke of the second key.

9. The mouse having a digital key and an analog key according to claim 8, wherein the limiting mechanism includes a limit adjusting screw, the limit adjusting screw being arranged at a position corresponding to the bottom surface of the second key of the mouse body, and the height adjusting position being adjustable when the limit adjusting screw is rotated, so that the distance between the end of the limit adjusting screw and the bottom surface of the second key is changed to adjust the pressing stroke of the second key.

10. The mouse having a digital key and an analog key according to claim 1, wherein the second key is disposed at a position where a top surface of the mouse body is adjacent to a rear side of the first key or is disposed at a side surface of the mouse body.
